(19) United States
(12) Patent Application Publication
(10) Pub. No.: US 2014/0328144 A1
(43) Pub. Date: Nov. 6, 2014

(54) CASING FOR ACOUSTIC COUPLING WITH A SUBSTRATE IN SEISMIC INVESTIGATIONS

(71) Applicant: GEODESIGN LTD., Calgary (CA)

(72) Inventor: Ross William Huntley, Grand Bend (CA)

(73) Assignee: GEODESIGN LTD., Calgary (CA)

(21) Appl. No.: 14/074,805

(22) Filed: Nov. 8, 2013

Related U.S. Application Data
(60) Provisional application No. 61/819,087, filed on May 3, 2013.

(51) Int. Cl. G01V 1/16

(52) U.S. Cl. CPC G01V 1/166
USPC 367/188

(57) ABSTRACT

An improved casing apparatus is provided for coupling of seismic receivers, such as a geophone, to a substrate for the gathering of seismic data.

### CROSS REFERENCE TO RELATED APPLICATIONS

This non-provisional application claims priority from U.S. provisional application U.S. 61/819,087 filed on May 3, 2013, which is incorporated herein by reference in its entirety.

### FIELD OF THE INVENTION

The invention generally relates to geophone and hydrophone casings for use in the placement of geophone or hydrophone instruments in the ground for use in geophysical or geotechnical surveys.

### BACKGROUND

Geophones are electronic devices that are designed to pick up seismic vibrations. They generally comprise one or more component sensors and may include a single vertical component or up to three components oriented along orthogonal axis.

Hydrophones are electronic devices that are designed to detect pressure changes in water.

Geophones and hydrophones are used in geophysical and geotechnical surveys including seismic reflection and refraction surveys, passive seismic surveys on the surface, and geotechnical seismic experiments. The majority of surface seismic experiments and surveys are done on ground surfaces which have varying depths of organic layers or layers mixed with organic materials, typically from 20 centimeters to 100 centimeters in thickness. These upper layers provide poor acoustic coupling for existing geophone installations such as mash cases and typically allow wind and other acoustic energy from the air to interfere with the sensing of energy in the ground.

Geophysical and geotechnical surveys including seismic reflection and refraction surveys, passive seismic surveys on the surface, and geotechnical seismic experiments, collectively referred to as “seismic surveys”, are typically conducted by distributing an array of geophones or hydrophones over a survey area, which are then used to detect vibrations in the soil or pressure changes in the groundwater, in particular, from the reflected or refracted sound waves from an acoustic source, such as an explosion. The data collected from the instruments is then analyzed to map the subsurface of the survey area.

Modern geophones are highly sensitive, which makes it essential to provide effective coupling of the assembly to the adjacent substrate.

Prior art surface seismic surveys place the geophones either above the ground or below using buried geophones. Below ground installations require a drilled hole wherein a geophone is grouted or cemented at a desired depth in the ground typically from 9 to 30 meters deep. The geophones used for this type of installation are for all practical purposes non-recoverable.

Small diameter threaded rods are also used in other above ground applications. In other cases geophones are attached to mine faces by means of connectors. In all cases, as in the present invention, the objective is to obtain effective coupling between the geophone and adjacent substrate in order to receive the seismic signal transmitted through the substrate.

The apparatus and method according the present invention allows the geophone to be reliably coupled to the adjacent substrate at a depth below the organically dominated layers, thereby reducing wind noise signal inputs and also increasing the frequency content sensed by the geophone as a result of improved coupling with the substrate. On completion of a survey, the removal of the casing permits the recovery of all the geophone or hydrophone components.

### BRIEF DESCRIPTION OF THE DRAWINGS

Embodiments of the invention will be shown in relation to the drawings in which:

FIG. 1 shows a side view of an assembly.

FIG. 2 shows a sectional side view of the assembly in FIG. 1, along plane A, with a schematic illustration of geophone instruments.

FIG. 3 shows a side view of an assembly.

FIG. 4 shows a sectional side view of the assembly in FIG. 3, along plane A, with a schematic illustration of hydrophone instruments.

FIG. 5A shows a sectional side view of an open head drive mechanism of an assembly.

FIG. 5B shows a top view of an open head drive mechanism of an assembly.

FIG. 5C shows a bottom view of an open head drive mechanism of an assembly.

FIG. 6A shows a sectional side view of a closed head drive mechanism of an assembly.

FIG. 6B shows a top view of a closed head drive mechanism of an assembly.

FIG. 6C shows a bottom view of a closed head drive mechanism of an assembly.

### DETAILED DESCRIPTION

The following terms, used in the present application, are defined by the definitions accompanying them. A “geophone subassembly” refers to one or more geophone instrument components and may include other components, such as signal filters, amplifiers or conditioners. “Screw insertion” refers to a type of insertion of the casing into a substrate whereby the casing, with helical threads around the periphery of its external surface, is brought into contact with a substrate and rotated about its vertical axis. The threads on the external surface of the casing rotationally engage the substrate and thereby penetrate into the substrate. A “substrate” refers to soil, earth rock or other surfaces within which placement of and coupling of geophone elements is desired. “Acoustic coupling” refers to a connection that transmits sound waves.

In order that the invention may be more clearly understood, preferred embodiments thereof will now be described in detail by way of example, with reference to the accompanying drawings.

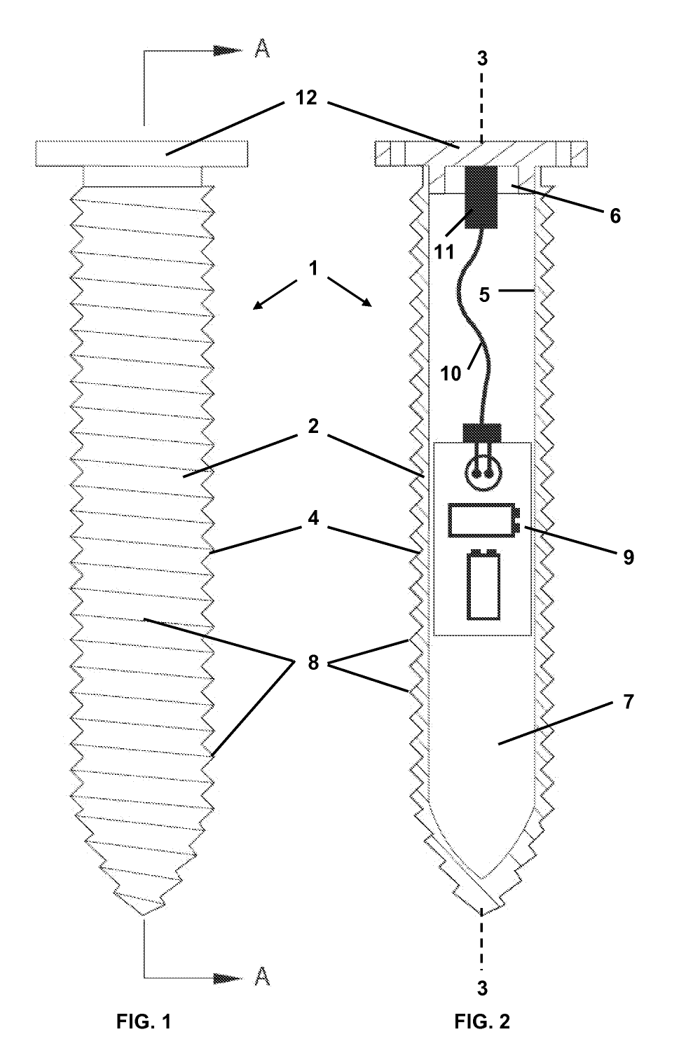

Referring to FIGS. 1 and 2, an assembly 1 comprises a casing 2, which has a vertical axis 3, an outside surface 4, an inside surface 5, an open top end 6 and an accessible space 7 therewithin, screw threads 8 formed integrally therewith around the periphery of the casing 2, geophone elements 9, a connection cable 10, a connector 11 and a head drive mechanism 12 for engagement with a complementary tool (not shown) for the purpose of rotating the casing 2 about the vertical axis 3 to thereby screw the assembly 1 into the substrate.

The casing 2 may be constructed of any material, such as a metal alloy or polymer, suitably rigid and durable to resist the forces exerted upon it and provide acoustic coupling with the desired substrate. Preferably, the casing 2 is cylindrical in shape, has a tapered bottom end that is generally conical and is between 50 cm and 100 cm in length. Other shapes of casing may be used, so long as the screw threads 8 extend beyond the periphery of the outside surface 4 of the casing 2 and the bottom end of the casing 2 is pointedly shaped to facilitate initial insertion into the ground or substrate.

The size of the accessible space 7, defined by the inside surface 5 of casing 2, may vary in different embodiments of the assembly 1 according to the present invention, depending on the space required for the geophone elements 9 in each application. Methods of attachment of the geophone elements 9 inside the casing 2 will also vary as required.

The screw threads 8 around the periphery of the casing 2, shown in FIG. 1, extend substantially the full length of the casing 2, but the assembly 1 according to the present invention may have screw threads 8 around the periphery of less than the full length of the casing 2. The screw threads 8, which may vary in size, increase the surface area of the outside surface 4 of the casing 2, thereby improving the coupling of the assembly 1 to the adjacent substrate.

FIG. 2 illustrates preferred geophone elements 9 comprising a 3 component geophone subassembly, within the accessible space 7 defined by the inside surface 5 of casing 2. The geophone elements 9 of the present invention may comprise other well known geophone subassemblies, including a single component geophone subassembly. Geophone elements 9 may be fixedly or releasably attached to the inside surface 5 of casing 2, by any well known method, so long as the attachment provides necessary acoustic coupling of the geophone elements 9 with the casing 2.

The casing 2 is preferably of a length sufficient to allow the geophone elements 9 to be coupled at a depth below the organically dominated layers of soil, thus reducing wind noise and providing a better seismic signal, by increasing the frequency content sensed by the geophone elements 9, as a result of the improved coupling with the adjacent substrate. More preferably, the casing 2 is of a length between 50 cm and 100 cm. The length of the casing 2 may vary or be extended, as is well known in the art, as required by the particular application.

The connection cable 10 is preferably a flexible multiconductor cable, but may be any type of connection well known in the art, capable of transmitting the signal produced by the geophone elements 9 to the connector 11. The connector 11 may be any type of connector well known in the art and can include any vendor specific recording system connector.

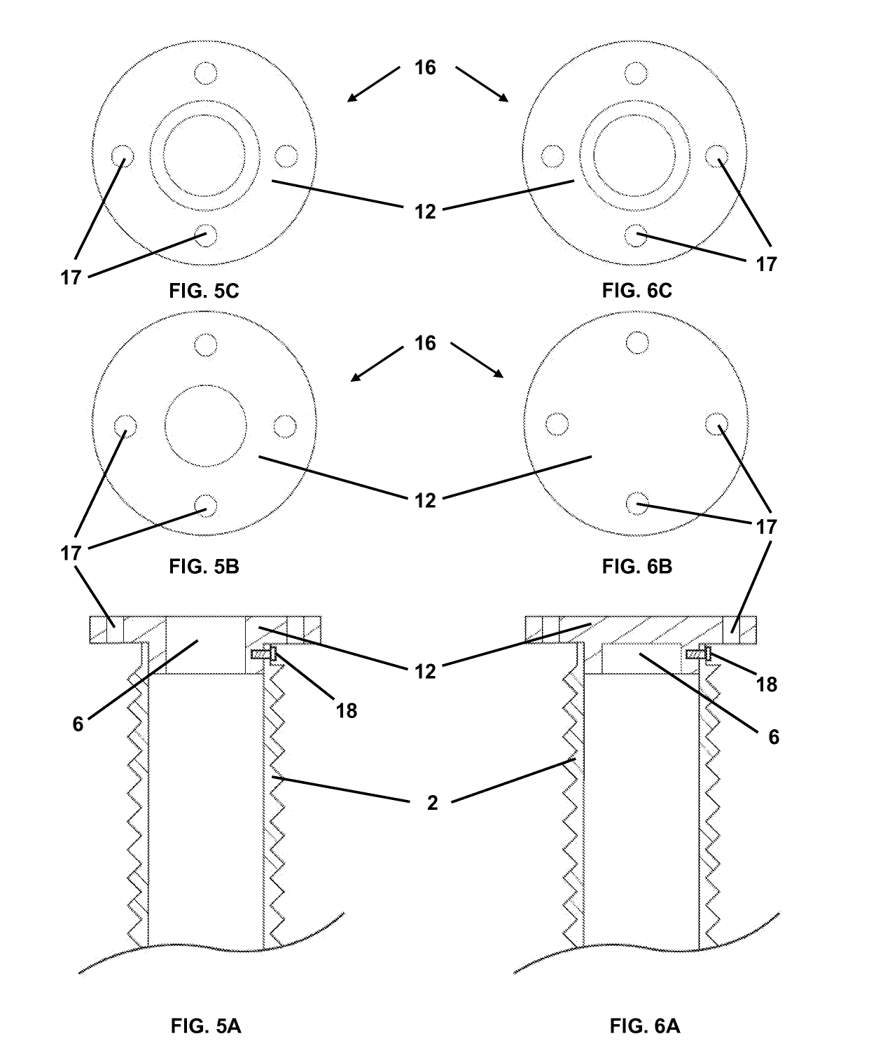

The head drive mechanism 12, illustrated in FIGS. 5A, B and C and 6A, B and C, may be any type of flange 16, having a slot, hole, lug, socket, nut, or preferably one or more holes 17 suitable for engagement by a complementary tool (not shown) for rotating the casing 2 about its vertical axis 3, such as a drill, bar or wrench of a size and configuration desired for the particular application and to impart rotation to the casing 2 for screw insertion of the assembly 1 into the substrate. Screw insertion of the assembly 1 compresses the substrate against the casing 2 and provides the desired acoustic coupling therewith.

The flange 16, of the preferred head drive mechanism 12, preferably has an arrangement of four holes 17 near the peripheral edge of the flange 16. Preferably, flange 16 is releasably attached to, and closes the open top end 6 of casing 2, by a lock screw 18.

If the head drive mechanism 12 instead has a socket or nut, or if the head drive mechanism 12 is otherwise configured such that it does not close the open top end 6 of the casing 2, then a cap or plug may be necessary to close the open top end 6 of the casing 2 to protect the internal components. This cap or plug may be a part of, or separate from, the head drive mechanism 12.

The tool is preferably a wrench having at least two, but preferably four, lugs of a complementary size to the holes 17 on the flange 16, for engagement with the holes 17 to enable rotation of the casing 2.

The head drive mechanism 12 may be constructed of any material, such as a metal alloy or polymer, suitably rigid and durable to withstand the forces applied to it by the tool, during screw insertion of the assembly 1 into the substrate, so that the assembly 1 may be recovered and used again.

The head drive mechanism 12, fitted within the open top end 6 of the casing 2, may be fixedly attached, by any well known method of attachment such as welding, to the open top end 6 of casing 2, or releasably attached by any other well known method of attachment, such as threadable engagement or friction fit. A lock screw 18 may be used. The attachment must be sufficiently durable to withstand the forces imparted by rotating the head drive mechanism 12.

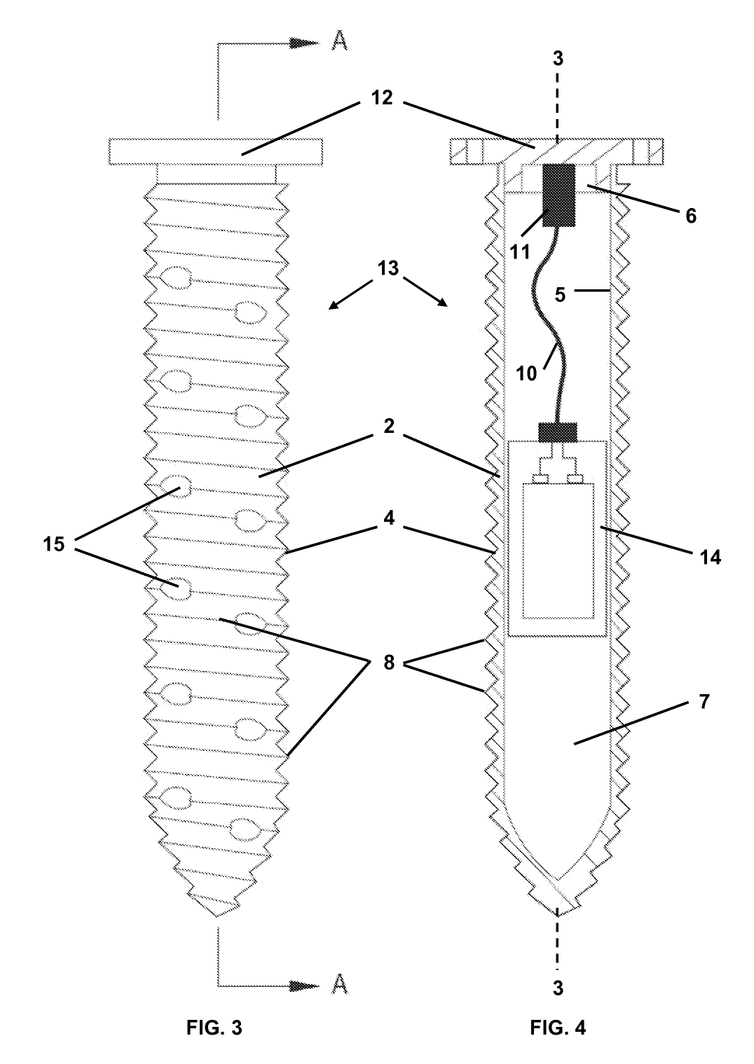

Referring to FIGS. 3 and 4, the above description of an assembly 1 applies equally to an assembly 13 with the substitution of hydrophone elements 14 for geophone elements 9 and the addition of casing perforations 15 to allow water to enter the accessible space 7.

The accessible space 7 illustrated in this embodiment of the present invention, is in fluid communication with the exterior of the assembly 13 through the casing perforations 15. This allows water to enter the accessible space 7 and the hydrophone elements 14 to detect changes in the water pressure corresponding to an acoustic signal.

The use of an assembly 1 or an assembly 13 according to the present invention typically allows the recovery of the assembly and all associated components, which may then be reused in subsequent geophysical or geotechnical surveys. The assembly is readily recovered by unscrewing the assembly from the earth.

Other advantages which are inherent to the invention are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

What is claimed is:

1. An assembly for screw insertion into a substrate for the purpose of acoustic coupling therewith comprising:
a casing having a vertical axis, an outside surface, an inside surface, an open top end and an accessible space therewithin;
said casing having screw threads formed integrally therewith around the periphery of said casing, said screw threads extending at least along a vertical portion of said outside surface of said casing, for screw insertion into said substrate; and
said casing having a head drive mechanism for operative engagement with a tool whereby said tool is used to rotate said casing about its vertical axis to thereby screw the casing into said substrate.

2. The assembly according to claim 1, having geophone elements within said accessible space.

3. The assembly according to claim 1, having acoustic damping material in said accessible space between said geophone elements and said head drive mechanism.

4. The assembly according to claim 1, wherein said casing has a tapered bottom end.

5. The assembly according to claim 4, wherein said casing is cylindrical in shape and said tapered bottom end is generally conical.

6. The assembly according to claim 4, wherein said tapered bottom end is at least partially threaded.

7. The assembly according to claim 1, wherein said head drive mechanism is a flange attached to said casing at said open top end.

8. The assembly according to claim 1, wherein said head drive mechanism comprises a slot, hole, socket or nut.

9. The assembly according to claim 1, wherein said open top end of said casing is closed by said head drive mechanism or a cap or plug.

10. The assembly according to claim 8, wherein said tool is a drill, bar or wrench.

11. The assembly according to claim 1, wherein said geophone elements are fixedly attached to said inside surface of said casing.

12. The assembly according to claim 1, wherein said geophone elements are releasably attached to said inside surface of said casing.

13. An assembly for screw insertion into a substrate for the purpose of acoustic coupling with water therein comprising:
a casing having a vertical axis, an outside surface, an inside surface, an open top end, an accessible space therewithin and casing perforations that allow fluid communication between said accessible space and the space outside the casing;
said casing having screw threads formed integrally therewith around the periphery of said casing, said screw threads extending at least along a vertical portion of said outside surface of said casing, for screw insertion into said substrate; and
said casing having a head drive mechanism mechanism for operative engagement with a tool whereby said tool is used to rotate said casing about its vertical axis to thereby screw the casing into said substrate.

14. The assembly according to claim 13, having hydrophone elements within said accessible space.

15. The assembly according to claim 13, having acoustic damping material in said accessible space between said hydrophone elements and said head drive mechanism.

16. The assembly according to claim 13, wherein said casing has a tapered bottom end.

17. The assembly according to claim 16, wherein said casing is cylindrical in shape and said tapered bottom end is generally conical.

18. The assembly according to claim 15, wherein said tapered bottom end is at least partially threaded.

19. The assembly according to claim 13, wherein said head drive mechanism is a flange attached to said casing at said open top end.

20. The assembly according to claim 13, wherein said head drive mechanism comprises a slot, hole, socket or nut.

21. The assembly according to claim 13, wherein said open top end of said casing is closed by said head drive mechanism or a cap or plug.

22. The assembly according to claim 20, wherein said tool is a drill, bar or wrench.

23. The assembly according to claim 13, wherein said hydrophone elements are fixedly attached to said inside surface of said casing.

24. The assembly according to claim 13, wherein said hydrophone elements are releasably attached to said inside surface of said casing.
